(19) United States
(12) Patent Application Publication
(10) Pub. No.: US 2026/0369701 A1
(43) Pub. Date: Nov. 19, 2026

(54) Systems and Methods of Dry Coating of Lithium Iron Phosphate (LFP) type Cathode Materials for Secondary Lithium Batteries

(71) Applicants: Venkatraman Prabhakar, Livermore, CA (US); Jason Travis Tillman, Livermore, CA (US); Gulin Vardar Irragang, Livermore, CA (US)

(72) Inventors: Venkatraman Prabhakar, Livermore, CA (US); Jason Travis Tillman, Livermore, CA (US); Gulin Vardar Irragang, Livermore, CA (US)

(73) Assignee: Sparkz Inc., Livermore, CA (US)

(21) Appl. No.: 19/207,814

(22) Filed: May 14, 2025

(51) Int. Cl. H01M 10/42; H01M 4/02; H01M 4/133; H01M 4/136; H01M 4/1393; H01M 4/1397; H01M 4/36; H01M 4/58; H01M 4/587; H01M 10/0562; H01M 10/0565

(52) U.S. Cl. CPC H01M 10/4235; H01M 4/133; H01M 4/136; H01M 4/1393; H01M 4/1397; H01M 4/364; H01M 4/5825; H01M 4/587; H01M 10/0562; H01M 10/0565; H01M 2004/027; H01M 2004/028

(57) ABSTRACT

The invention relates to a process for coating cathode active materials for use as positive electrode in lithium batteries. The invention may provide a process of coating a carbon coated cathode active material with an oxide or nitride or carbide layer. The oxide or nitride or carbide coating increases cycle life of the cathode active material by protecting its surface from degradation. The prepared material may have improved electrochemical performance than the non-coated material.

### RELATED APPLICATIONS

This application claims benefit and priority of U.S. provisional patent application No. 63/647,762, filed May 15, 2024, which is incorporated herein by reference in its entirety.

### FIELD OF THE INVENTION

The present invention is related to a process for coating cathode active materials and especially a carbon coated LiFeMₓPO_{4+y} cathode material and its use in rechargeable Li-ion batteries.

### BACKGROUND

Lithium iron phosphate (LFP) is an environmentally friendly cathode, delivering a capacity of around 160 mAh/g with a cost below $15/kg. Lithium iron phosphate material has a robust structure due to the stability of P-O bound and able to cycle reversibly for thousands of cycles safely, for low charging rates. However, at high charging rates, the surface of the cathode active material degrades, and the capacity of the secondary lithium battery decreases.

### BRIEF DESCRIPTION OF THE DRAWINGS

FIG. 1 shows a process of oxide or nitride or carbide coating of the carbon coated LiFeMₓPO_{4+y} cathode material, where M: Mg, Mn, Ca, Sr, Ba, Ce, Th, Zr, Hf, Ti, W, Al, Zn, Mn, Ni, Cr, Y and 0<x<0.03, 0<y<0.006.

FIG. 2 shows a result of oxide or nitride or carbide coating of the carbon coated LiFeMₓPO_{4+y} cathode material, where M: Mg, Mn, Ca, Sr, Ba, Ce, Th, Zr, Hf, Ti, W, Al, Zn, Mn, Ni, Cr, Y and 0<x<0.03, 0<y<0.006.

### DETAILED DESCRIPTION

Lithium iron phosphate can be coated by solution-based methods or by vacuum-assisted methods such as atomic layer deposition or pulsed layer deposition. Both methods have drawbacks. The solution-based methods expose the LiFePO₄ active material to solvents that can change the moisture content and require another drying step after the coating. The vacuum-assisted methods produce high quality coatings, however, introduce a high cost due to the increase in process time and complexity. The dry coating process is a much simpler process that involves mixing two dry powders in a mixer and coating the smaller particles onto the bigger particles by taking advantage of surface attractions.

In particular embodiments, a new cathode active material coating process, whereby the carbon-coated cathode active material is dry mixed with oxide or nitride or carbide particles of small particle size. The oxide or nitride or carbide particles coat the surface of the carbon-coated LiFeMₓPO_{4+y} (LFP) cathode material. This oxide or nitride or carbide coating can protect the surface of the LiFeMₓPO_{4+y} against degradation when the battery is charged at high currents.

The battery can include a liquid or a solid electrolyte. For example, the solid electrolyte can be: Li₃PO₄, lithium lanthanum titanium oxides (LLTO), Nasicon type phosphate such as Li_{1.3}Al_{0.3}Ti_{1.7}(PO₄)₃, LISICON such as Li₁₄ZnGe₄O₁₆, Garnet like Li₆La₂BaTa₂O₁₂, Li₆La₃ZrTaO₁₂, Mesoporous composites containing LiTaO₃, or amorphous LiPON or sulfide glass and their combinations oxide-type (e.g., (Li₇La₃Zr₂O₁₂ (LLZO), (LLZTO cubic garnets)), sulfate-type, perovskite-type.

For example, the solid electrolyte can be: polyethylene oxide based polymers, polypropylene oxide based polymers, polyvinyl alcohol based polymers, polyvinyl formal based polymers, siloxane based polymers or phosphazene based polymers, polyacrylonitrile based polymers, poly(methyl methacrylate) based polymers, polyvinyldene fluoride, polyethylene glycol, or succinonitrile.

The battery can include an anode material that contains graphite, silicon, Tin, Li₄Ti₅O₁₂, TiO₂ or lithium metal.

The coating process may not use any solvents and therefore, a drying step will not be necessary after this process to use the cathode active material in cells.

This process can take place in 20 °C to 400 °C.

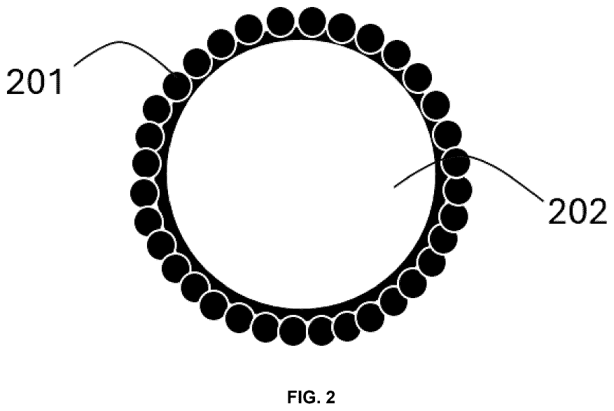

Exemplary embodiments of this invention may use oxide or nitride or carbide layers such as but not limited to Al₂O₃, SiO₂, TiO₂, ZrO₂, ZnO, MgO, Sb₂O₃, BaTiO₃, CeO₂, Co₃O₄, In₂O₃, IrO₂, Fe₃O₄, Fe₂O₃, Li₂°, NiO, Nb₂O₅, PtO₂, TiO₂, SnO₂, Y₂O₃, WC, B₄C, SiN, BN, CN to coat a carbon coated LiFeMₓPO_{4+y} material with a composition of 0<x<0.03, 0<y<0.006, where M: Mg, Mn, Ca, Sr, Ba, Ce, Th, Zr, Hf, Ti, W, Al, Zn, Mn, Ni, Cr, Y using dry mixing. The carbon weight amount in the final material can be between 0.5 and 3% of the final material. The particle sizes of the carbon coated LiFeMₓPO_{4+y} can be in the range of 0.1μm to 10μm. The particle size of coating particles can be significantly smaller and these particles may be in the 0.005μm to the 0.5μm range. The average coating particle can range from 1/20 of the average particle size of the carbon coated cathode active material to about half the average particle size of the carbon coated cathode active material particles. FIG. 2 shows a representative drawing of the coating particles (201) on carbon coated larger LiFeMₓPO_{4+y} particle (202). The average particle sizes may be measured using a laser diffraction method which can extract the full particle size distribution (PSD).

The oxide or nitride or carbide (e.g., Al₂O₃, SiO₂, TiO₂, ZrO₂, ZnO, MgO, Sb₂O₃, BaTiO₃, CeO₂, Co₃O₄, In₂O₃, IrO₂, Fe₃O₄, Fe₂O₃, Li₂°, NiO, Nb₂O₅, PtO₂, TiO₂, SnO₂, Y₂O₃, WC, B₄C, SiN, BN, CN) coating protects the surface of the LiFeMₓPO_{4+y} material against degradation by limiting the interaction between the electrolyte and the cathode active material. During fast charging, the surface of the cathode active material is more prone to degradation and therefore, cells using oxide or nitride or carbide coated LiFeMₓPO_{4+y} material as the cathode active material may exhibit longer cycle life with fast charging.

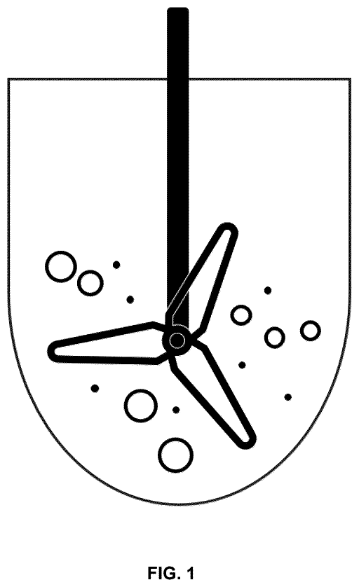

The process of oxide or nitride or carbide (e.g., Al₂O₃, SiO₂, TiO₂, ZrO₂, ZnO, MgO, Sb₂O₃, BaTiO₃, CeO₂, Co₃O₄, In₂O₃, IrO₂, Fe₃O₄, Fe₂O₃, Li₂°, NiO, Nb₂O₅, PtO₂, TiO₂, SnO₂, Y₂O₃, WC, B₄C, SiN, BN, CN) coating of the carbon coated LiFeMₓPO_{4+y} cathode material (e.g., M: Mg, Mn, Ca, Sr, Ba, Ce, Th, Zr, Hf, Ti, W, Al, Zn, Mn, Ni, Cr, Y and 0<x<0.03, 0<y<0.006) is presented in the FIG. 1.

The result of oxide or nitride or carbide (Al₂O₃, SiO₂, TiO₂, ZrO₂, ZnO, MgO, Sb₂O₃, BaTiO₃, CeO₂, Co₃O₄, In₂O₃, IrO₂, Fe₃O₄, Fe₂O₃, Li₂°, NiO, Nb₂O₅, PtO₂, TiO₂, SnO₂, Y₂O₃, WC, B₄C, SiN, BN, CN) coating of the carbon coated LiFeMₓPO_{4+y} cathode material (e.g., M: Mg, Mn, Ca, Sr, Ba, Ce, Th, Zr, Hf, Ti, W, Al, Zn, Mn, Ni, Cr, Y and 0<x<0.03, 0<y<0.006) is presented in FIG. 2.

What is claimed is:

1. A method, comprising:
a) coating a coating material that is an oxide or nitride or carbide layer on top of a carbon coated LiFeMₓPO_{4+y} material;
b) wherein the LiFeMₓPO_{4+y} material has a composition of 0<x<0.03, 0<y<0.006, wherein M is Mg, Ca, Sr, Ba, Ce, Th, Zr, Hf, Ti, W, Al, Zn, Mn, Ni, Cr, or Y; and
c) wherein the coating material is coated on the LiFeMₓPO_{4+y} material using a dry method without liquids solvents or water liquids.

2. The method of claim 1, further comprising forming a cathode material for a rechargeable lithium battery.

3. The method of claim 2, wherein a carbon amount in the cathode material is between 0.1% and 3% of a total cathode weight.

4. The method of claim 1, wherein the coating material is coated using a mixer without a solvent.

5. The method of claim 2, wherein the rechargeable battery comprises an anode active material having graphite, silicon, Tin, Li₄Ti₅O₁₂, TiO₂ or lithium metal.

6. The method of claim 2, wherein the rechargeable battery comprises an electrolyte that is a liquid or a solid electrolyte.

7. The method of claim 6, wherein the solid electrolyte comprises at least one of: Li₃PO₄ lithium lanthanum titanium oxides (LLTO), Nasicon type phosphate, LISICON, Garnet, Mesoporous composites containing LiTaO₃, or amorphous LiPON or sulfide glass, sulfate-type, and perovskite-type.

8. The method of claim 6, wherein the solid electrolyte comprises at least one of:
polyethylene oxide-based polymers, polypropylene oxide-based polymers, polyvinyl alcohol-based polymers, polyvinyl formal based polymers, siloxane-based polymers or phosphazene based polymers, polyacrylonitrile based polymers, poly(methyl methacrylate)-based polymers, polyvinyldene fluoride, polyethylene glycol, and succinonitrile.

9. The method of claim 1, wherein a high shear and dispersion dry mixer is used for the coating.

10. The method of claim 1, wherein there is no drying step after the coating step.

11. The method of claim 1, wherein the coating is performed at a temperature between 20 °C and 400 °C.

12. The method of claim 1, wherein the coating is performed at a temperature between 20 °C and 150 °C.

13. The method of claim 1, further comprising a mixing step that is performed with the LiFeMₓPO_{4+y} material and the coating material.
